(19) United States
(12) Patent Application Publication
(10) Pub. No.: US 2007/0149385 A1
(43) Pub. Date: Jun. 28, 2007

(54) Catalyst system for reducing nitrogen oxide emissions

(76) Inventors: Ke Liu, RanchSanta Margarita, CA (US); Jonathan Lloyd Male, Schoharie, NY (US); Harish Radhakrishna Acharya, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/316,538

(22) Filed: Dec. 23, 2005

(51) Int. Cl. B01J 27/182; B01J 27/00; B01J 29/08; B01J 29/00; B01J 29/04; B01J 29/87; B01J 21/00

(52) U.S. Cl. 502/60; 502/214; 502/208; 502/77; 502/79

(57) ABSTRACT

A multi-functional catalyst composition is provided. The multi-functional catalyst composition comprises a cracking catalyst material capable of enabling the conversion of the primary hydrocarbon into at least one secondary hydrocarbon having a lower molecular weight than the primary hydrocarbon, and a selective catalytic reduction (SCR) material capable of enabling the chemical reduction of NOx species. Further embodiments presented include a catalyst system comprising the catalyst, an apparatus for reducing NOx emissions comprising the catalyst system, and a method for making the catalyst material.

### BACKGROUND

This invention relates to catalysts for reducing harmful exhaust emissions. More particularly, this invention relates to a multi-functional catalyst composition for reducing nitrogen oxide (NOₓ) emissions from engines that use hydrocarbon-based fuels, and to methods and systems for making and using such a composition.

Production of emissions from mobile and stationary combustion sources such as locomotives, vehicles, power plants and the like, has resulted in environmental pollution. One particular source of such emissions is NOₓ emissions from vehicles. Environmental legislation restricts the amount of NOₓ that can be emitted by vehicles. In order to comply with this legislation, efforts have been directed at reducing the amount of NOₓ emissions.

One method of emission reduction is directed to minimizing the amount of NOₓ emissions produced during the process of combustion in engines. This method generally involves redesigning engines to optimize the combustion of fuel, such as the EGR (Exhaust Gas Recycle) approach in recent years. This approach has resulted in the reduction of NOₓ over the years; however, the redesign approach requires a number of significant engine changes, and as a result is an expensive undertaking.

Another method of emissions reduction is the use of an exhaust aftertreatment system, which usually involves reacting the engine exhaust, often in the presence of one or more catalysts, to reduce the NOₓ content of the exhaust stream. In one example, a solution of ammonia or urea contacts the exhaust stream to reduce the NOₓ to nitrogen, water and carbon dioxide (if urea is used). This method is disadvantageous in that potentially toxic chemicals such as ammonia may have to be carried on vehicles and maintained at sufficient levels for NOₓ reduction; moreover, an infrastructure of urea refueling stations would have to be built around the country to support vehicles, such as locomotives, using this approach. In another example, the “lean NOₓ trap” method involves the dispersion of metal catalysts onto substrates such as, for example, barium oxide (BaO), calcium oxide (CaO) or barium carbonate (BaCO₃) to form NOₓ traps. When, for instance, BaO is saturated with NOₓ, thus forming barium nitrate, Ba(NO₃)₂, reductants are used to reduce the NOₓ collected in the form of (NO₃)⁻ in Ba(NO₃)₂ to N₂ and H₂O while returning the substrate to BaO. NOₓ emissions into the atmosphere are then reduced in this way. The cycle is then repeated. This method requires a large NOₓ trap, often in a dual bed arrangement. For application on a locomotive or other mobile combustion sources, this method of reducing NOₓ may be too expensive and may take considerable space.

In another example of an aftertreatment system, the exhaust is reacted with light (typically C2-C8) hydrocarbon species (“reductants”) in the presence of a selective catalytic reduction (SCR) catalyst to reduce the NOₓ species into nitrogen and other less harmful components (“reductant/SCR systems”). In certain cases the reductant is supplied by first “cracking” a portion of the hydrocarbon-based fuel (such as diesel fuel) to form lighter hydrocarbon species (along with some H₂ and CO) suitable for use as reductants; this is done in the presence of a so-called “cracking catalyst.” Although effective in reducing the NOx emissions levels, this system also has certain disadvantages, such as the need to regenerate the cracking catalyst due to the build-up of coke and other byproducts of the cracking reaction, and the need for multiple reactor beds and other supporting system infrastructure to contain and support separate cracking and SCR catalyst materials.

Based on the above, there remains a need for efficient systems for reducing NOx emissions from engines.

### BRIEF DESCRIPTION

Embodiments of the present invention meet these and other needs. One embodiment is a catalyst system comprising a fluid reductant source comprising a primary hydrocarbon; and a multi-functional catalyst composition disposed in fluid communication with the reductant source. The multi-functional catalyst composition comprises a cracking catalyst material capable of enabling the conversion of the primary hydrocarbon into at least one secondary hydrocarbon having a lower molecular weight than the primary hydrocarbon, and a selective catalytic reduction (SCR) material capable of enabling the chemical reduction of NOₓ species.

Another embodiment is an apparatus for reducing NOₓ emissions, comprising: an engine configured to bum a hydrocarbon-based fuel and create an emission; and an emissions control system configured to accept the emission from the engine. The emissions control system comprises a reductant injector configured to supply a primary hydrocarbon; and the multi-functional catalyst composition described above, disposed in fluid communication with the reductant injector.

Another embodiment is a method for making a catalyst material, comprising: providing a primary material, the primary material comprising a zeolite; and disposing a secondary material with the primary material, wherein the secondary material comprises a selective catalytic reduction (SCR) material.

Another embodiment is the multi-functional catalyst composition described above.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an apparatus for reducing NOₓ emissions in accordance with particular embodiments of the invention.

### DETAILED DESCRIPTION

Embodiments of the present invention provide a more efficient alternative to more conventional reductant/SCR systems. Instead of using separate catalyst compositions to provide the fuel cracking function, the selective catalytic reduction (SCR) function, and, in some cases, other important functions, embodiments of the present invention provide for all such functions to occur efficiently in one catalyst formulation. Such high functionality may result in reduced costs, such as through the elimination of separate systems for fuel cracking, regeneration, and NOₓ reduction; moreover, the elimination of these system components may result in reduced weight and system footprint, which would prove advantageous for applications involving mobile systems such as locomotives and other vehicles or any other system with a space restriction.

In accordance with embodiments of the present invention, a catalyst system comprises a source of a fluid reductant and a multi-functional catalyst composition disposed in fluid communication with the reductant source. The reductant source comprises a primary hydrocarbon. The primary hydrocarbon, in some embodiments, comprises one or more of the hydrocarbon-based liquid engine fuels, of which diesel fuel is an example. In these embodiments, a portion of the fuel used to power an engine is diverted from the engine and is provided directly, such as by atomization or a spray method, to the multi-functional catalyst, whereupon the fuel is “cracked” into lighter hydrocarbon compounds and other byproducts, which may be used as reductants to reduce NOₓ species. In alternative embodiments, the primary hydrocarbon comprises a hydrocarbon species suitable for use directly as a reductant, such as an alkane, an alkene, an alcohol, an ether, an ester, a carboxylic acid, an aldehyde, a ketone, a carbonate, and combinations thereof. Specific examples of such compounds include ethane, ethylene, propane, propylene, butane, butene, pentane, pentene, hexane, hexene, heptane, heptene, octane, octane, 2,2,4-trimethyl pentane, methanol, ethyl alcohol, butyl alcohol, propyl alcohol, dimethyl ether, dimethyl carbonate, acetaldehyde, acetone, and other species having similar reductant properties.

The multi-functional catalyst composition comprises an integration of multiple components, each component providing some function for reducing NOₓ emissions. As will be discussed in more detail below, the various components are not maintained in separate reactors throughout an aftertreatment system, but exist as one composition. The components may exist as an admixture, or one component may be disposed onto another component.

The first component of the multi-functional catalyst is a cracking catalyst. The term “cracking catalyst” is known in the art to refer to those catalysts that enable reactions that convert a hydrocarbon material having a comparatively high molecular weight into one or more hydrocarbon species having lower molecular weight. Here, the cracking catalyst material enables conversion of the primary hydrocarbon into at least one secondary hydrocarbon having a lower molecular weight than the primary hydrocarbon. This cracking component conveniently allows the production of reductant species from the very fuel powering the engine.

In one embodiment, the cracking catalyst material comprises a zeolite. Zeolites are well known in the art of catalysis and are particularly favored for their effectiveness in enabling cracking of heavy hydrocarbons in the petrochemical industry. Zeolite crystals have a regular network of very small diameter pores, the size and nature of which can be controlled by controlling the chemistry and processing of the zeolite. Zeolites are composed of silicon or aluminum atoms tetrahedrally surrounded by four oxygen atoms. A tetrahedron containing silicon is neutral in charge, while each tetrahedron containing aluminum has a net charge of −1 which must be balanced by a positive ion such as a proton. Protons that balance the negative charge of aluminum tetrahedra have strong acidity, which is known to catalyze cracking reactions. Thus the catalyzing properties of the zeolite, in addition to being controlled by controlling pore size, may be further controlled by proper selection of the so-called “silicon to aluminum ratio” of the zeolite, that is, the relative amounts of aluminum and silicon in the zeolite.

A wide variety of zeolites is available commercially, and the properties of the various “grades” of zeolites are well-known. Certain forms of zeolite are highly suitable for use in embodiments of the present invention. In some embodiments, the zeolite comprises an aluminophosphate, a silicoaluminophosphate, or a combination comprising at least one of the foregoing zeolites. In certain embodiments the zeolite comprises one or more of the following compositions: ultrastable Y zeolite (USY), beta zeolite, ZSM-5, ZSM-11, ZSM-22, ZSM-35, MCM-22, MCM-36, MCM-41, MCM-48, or SAPO-34, or a combination comprising at least one of the foregoing zeolites. Those skilled in the art will recognize that rare earth substituted forms of any of the foregoing zeolites may be suitable as well.

The zeolite compositions listed above have properties especially suited for use in embodiments of the present invention. For instance, the composition known to the art as ZSM-5 contains channel openings of 5.1 to 5.6 Angstroms, a size range that is highly suitable for converting fuel to reductant species. Moreover, ZSM-5 contains strong Brönsted acid sites, and reportedly does not catalyze coke formation as readily as other zeolites.

The second component of the multifunctional catalyst is a selective catalytic reduction (SCR) catalyst material. SCR catalysts are those catalyst materials that enable the chemical reduction of NOₓ species to less harmful constituents such as nitrogen (N₂). The SCR material may be present in the multi-functional catalyst composition as a simple mixture with the cracking catalyst material, or, in certain embodiments, the SCR material is disposed onto the cracking catalyst by any of various processes known in the art. For example, where the cracking catalyst is a zeolite, the SCR material may be disposed onto the zeolite material.

There are many different SCR catalyst materials known in the art. Any of those SCR catalyst materials that promote reduction of NOₓ species via reaction with hydrocarbon reductants may be suitable for use in the catalyst system described herein. Examples of suitable selective catalytic reduction catalysts include metals such as silver, gallium, cobalt, molybdenum, tungsten, indium, bismuth, vanadium or a combination comprising at least one of the foregoing metals, such as in a binary, ternary or quaternary mixture disposed upon a suitable support. Oxides of metals can be used as catalysts if desired. Oxides of metals can also be used as catalyst supports. Examples of suitable metal oxide supports are alumina, titania, zirconia, ceria, silicon carbide, or a combination comprising at least one of the foregoing supports. In certain embodiments, the SCR materials are disposed directly on the cracking catalyst material, so that the cracking catalyst material, such as the zeolite material described above, also serves as a support for the SCR material. Particular examples of suitable SCR materials, along with methods for making such materials and disposing them onto support materials, are described in U.S. patent application Ser. Nos. 10/743,646; 11/022,897; and 11/022,901.

In particular embodiments, the SCR material comprises a catalytic metal oxide, such as an oxide selected from the group consisting of gallium oxide, silver oxide, indium oxide, and cerium oxide. In further embodiments, the SCR material comprises a promoting metal in addition to the catalytic metal oxide. Examples of such promoting metal used in conjunction with the oxide include, but are not limited to, silver, cobalt, molybdenum, tungsten, indium, vanadium, zinc, tin, copper, iron, and bismuth. In particular instances, the SCR material comprises from about 5 mol % to about 31 mol % of the catalytic metal oxide and from about 0.5 mol % to about 9 mol % of the promoting metal, wherein the percentages are fractions of the total amount of SCR material present in the multi-functional catalyst. The total amount of SCR material present (“SCR loading”) in the multi-functional catalyst composition will vary in accordance with certain factors known to those in the art; examples of such factors include the type of SCR catalyst being used and the environment to which the material will be exposed. The selection of the SCR loading generally will be only a few percent, such as less than about 20 percent, of the total weight of the multi-functional catalyst composition.

In some embodiments, the multi-functional catalyst composition further comprises a catalytic partial oxidation (CPO) material. A CPO material is a catalyst endowed with two important capabilities. First, a CPO material is capable of enabling oxidation of coke deposits on the multifunctional catalyst. Coke build-up that occurs during the cracking of hydrocarbons while using cracking catalysts, such as zeolites, during processes such as fluidized catalytic cracking (FCC), deactivates the catalyst. The CPO material advantageously helps to remove the coke build-up on the surface of the cracking catalyst material, thereby retaining active sites for cracking appreciably longer than would be available if the CPO material were not present. Second, a CPO material is further capable of enabling the conversion of hydrocarbon species, such as the primary hydrocarbon and/or the secondary hydrocarbon described above, to syngas (a mixture of hydrogen and carbon monoxide). The syngas may be used in combination with the secondary hydrocarbon to facilitate reduction of NOₓ species in the presence of the SCR catalyst, as described above. In short, the presence of the CPO material advantageously provides means for preventing or delaying the degradation of the cracking catalyst material due to coke build-up, and further may aid in the production of species that serve to reduce NOx species in the presence of the SCR material. Moreover, because the catalytic partial oxidation reaction is an exothermic reaction, while cracking is an endothermic reaction, the heat generated at a catalytic partial oxidation site facilitates the endothermic cracking reaction in a neighboring cracking site and also facilitates the oxidation of coke.

The CPO material generally comprises one or more noble metals that perform the catalytic partial oxidation function. In particular embodiments, the CPO material comprises one or more “platinum group” metal components. As used herein, the term “platinum group” metal means rhodium, platinum, iridium, palladium, osmium, ruthenium, or mixtures of any of these. Exemplary platinum group metal components are rhodium, platinum, and optionally, iridium. The platinum-group metal is present in the multi-functional catalyst in an amount greater than about 0.1 weight percent, such as in a range from about 0.1 weight percent to about 5 weight percent. A particular exemplary composition for the CPO material is 0.5% Pt-0.5% Rh-0.25% Ir (percentages based on total loading by weight of multi-functional catalyst). In alternative embodiments, the platinum-group metal is present in the multi-functional catalyst in an amount of about 1 weight percent. The platinum group metal components optionally may be supplemented with one or more base metals and oxides of the metals, including, for example, base metals of Group VIII, Group IB, Group VB and Group VIB of the Periodic Table of Elements. Exemplary base metals include cerium, iron, cobalt, nickel, copper, vanadium, and chromium.

In certain embodiments, the CPO material is disposed on the cracking catalyst. This disposition may be accomplished using any of several techniques known in the art, such as, for example, wash coating with or without the use of an ion exchange mechanism. Those skilled in the art will appreciate that any of several viable pathways exist for the fabrication of cracking catalyst with CPO material disposed thereon. For instance, a zeolite catalyst may be formed first, followed by the dispersion of the CPO composition onto the zeolite. Alternatively, salt solutions of the metals to be used as CPO material may be incorporated into the solution used to form the zeolite, such that the zeolites are subsequently formed with CPO metals entrained therein. Moreover, in particular embodiments, both the SCR material and the CPO material are disposed onto the cracking catalyst, thereby creating a single catalyst composition which, in one reactor, can enable the manufacture of reductant (via hydrocarbon cracking), help reduce fouling of the surface by cracking byproducts (via catalytic partial oxidation), and use the reductant to lower NOₓ levels in the exhaust stream (via use of the SCR material).

The catalyst system may be used in conjunction with any process or system in which it may be desirable to reduce NOₓ emissions, such as a gas turbine; a steam turbine; a boiler; a locomotive; or a transportation exhaust system, such as, but not limited to, a diesel exhaust system. The catalyst system may also be used in conjunction with systems involving generating gases from burning coal, burning volatile organic compounds (VOC), or in the burning of plastics; or in silica plants, or in nitric acid plants. The multi-functional catalyst composition is typically placed at a location within an exhaust system where it will be exposed to effluent gas comprising NOₓ. The catalyst may be arranged as a packed or fluidized bed reactor, coated or extruded on a monolithic, foam, mesh or membrane support structure, or arranged in any other manner within the exhaust system such that the catalyst composition is in contact with the effluent gas. The catalyst components may be disposed uniformly throughout the surface area of a support, or they may be disposed in specific regions where their specific functionalities may be best served. For example, in some embodiments the CPO material may be disposed primarily on an upstream side of a catalyst support, where the need for its partial oxidation (coke-removing) functionality may be needed most; in certain designs this is the region where hydrocarbon cracking (with its attendant formation of coke) is most active, while the downstream side of the support may be primarily used for NOₓ reduction.

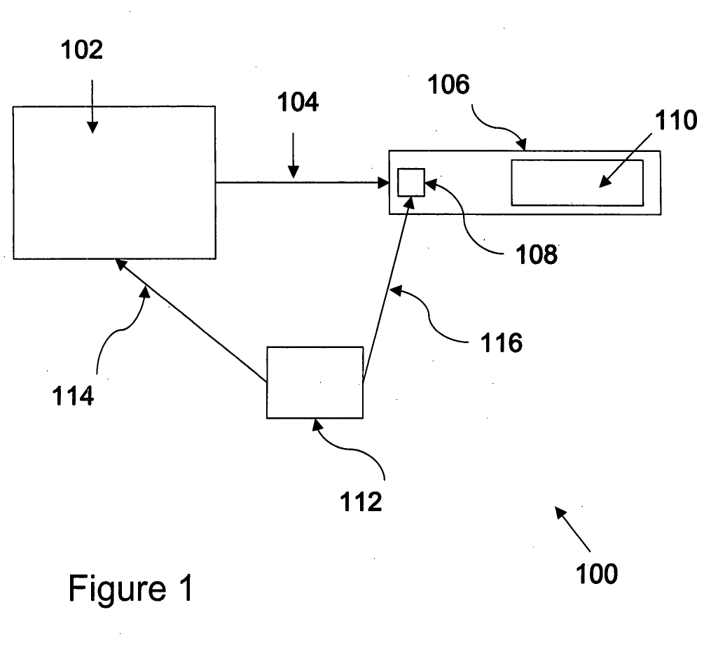

Certain embodiments of the present invention include a vehicle, such as, for example, a locomotive, an off-highway vehicle, or a diesel powered truck, comprising the catalyst system described above. Moreover, referring to FIG. 1, an apparatus 100 for reducing NOₓ emissions in accordance with particular embodiments, comprises an engine 102 that is configured to burn a hydrocarbon-based fuel, thereby creating an emission 104. A diesel engine is a particular example of such an engine. The apparatus 100 further comprises an emissions control system 106 that is configured to accept emission 104 from the engine 102. System 106 comprises a reductant injector 108 that is configured to supply a primary hydrocarbon. Injector 108 may be any device used to introduce a fluid into a gaseous stream, such as a spray injector, atomizer, or the like. System 106 further comprises the multi-functional catalyst composition 110 described above, disposed in fluid communication with reductant injector 108. In some embodiments, apparatus 100 further comprises a fuel delivery system 112. Fuel delivery system 112 is configured to provide a first stream 114 of fuel to engine 102 for combustion, and to provide a second stream 116 of fuel to reductant injector 108. Here, the fuel is used as the reductant source comprising the primary hydrocarbon. In other embodiments, a separate reductant supply system (not shown) may be used alone or in conjunction with the fuel delivery system to supply reductant to the catalyst composition 110.

Embodiments of the present invention further include a method for making a catalyst material. A primary material is provided. The primary material comprises a zeolite, including any of the varieties of zeolites described previously. A secondary material is disposed with the primary material. This secondary material comprises a selective catalytic reduction (SCR) material as described previously. Disposing the secondary material, in some embodiments, comprises disposing the secondary material on the primary material, as by wash coating, incipient wetness techniques, or any other suitable method understood by those in the art to be useful for disposing a catalyst onto a suitable support. In certain embodiments, a tertiary material, comprising a CPO material as described previously, is disposed with, and, in some embodiments, on, the primary material. The disposition of tertiary material may be accomplished by any suitable technique, such as those described above for the disposition of CPO material on the cracking catalyst material.

The primary material, with or without secondary and/or tertiary materials disposed on the primary material, may be disposed onto a suitable support structure, such as, for instance, a monolith structure or a foam structure; such supports and support geometries are commonly used in the art to support a catalyst composition and maintain it in contact with a fluid stream. As described above, these support structures, in some embodiments, comprise one or more ceramic support materials, such as metal oxides, of which aluminum oxide is an example. Conventional processes may be used to dispose the primary material onto the support. For example, the primary material may be wash coated onto the support structure, or the primary material may be mixed together with the support material to form a mixture (often a paste), which is subsequently extruded to form the support structure. It will be apparent to those skilled in the art that a number of different processing pathways exist for forming the support with multi-functional catalyst composition. For instance, particles of primary material (such as ZSM-5 zeolite) may have an SCR material and a CPO material disposed on them, and then these particles may be wash coated onto the support. Alternatively, the zeolite may be wash coated onto the support first, followed by wash coating the SCR and CPO materials onto the pre-coated support. In yet another example, the zeolite can be extruded with the support material to form the support, followed by wash coating the multi-functional catalyst composition, or simply the SCR and CPO materials, onto the zeolite-containing support.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. A catalyst system comprising:
a fluid reductant source comprising a primary hydrocarbon; and
a multi-functional catalyst composition disposed in fluid communication with the reductant source, wherein the multi-functional catalyst composition comprises
(a) a cracking catalyst material capable of enabling the conversion of the primary hydrocarbon into at least one secondary hydrocarbon having a lower molecular weight than the primary hydrocarbon, and
(b) a selective catalytic reduction (SCR) material capable of enabling the chemical reduction of NOₓ species.

2. The catalyst system of claim 1, wherein the multi-functional catalyst composition further comprises a catalytic partial oxidation (CPO) material capable of enabling oxidation of coke deposits on the multifunctional catalyst and enabling the conversion hydrocarbon species to hydrogen and carbon monoxide.

3. The catalyst system of claim 1, wherein the CPO material comprises a platinum-group metal.

4. The catalyst system of claim 3, wherein the platinum-group metal comprises an element selected from the group consisting of rhodium, platinum, iridium, palladium, osmium, and ruthenium.

5. The catalyst system of claim 3, wherein the platinum-group metal is present in the multi-functional catalyst in an amount in a range from about 0.1 weight percent to about 5 weight percent.

6. The catalyst system of claim 5, wherein the platinum-group metal is present in the multi-functional catalyst in an amount of about 1 weight percent.

7. The catalyst system of claim 2, wherein the CPO material is disposed on the cracking catalyst material.

8. The catalyst system of claim 7, wherein the SCR material is disposed on the cracking catalyst material.

9. The catalyst system of claim 1, wherein the cracking catalyst material comprises a zeolite.

10. The catalyst system of claim 9, wherein the zeolite comprises an aluminophosphate, a silicoaluminophosphate, or a combination comprising at least one of the foregoing zeolites.

11. The catalyst system of claim 9, wherein the zeolite comprises ultrastable Y zeolite (USY), beta zeolite, ZSM-5, ZSM-11, ZSM-22, ZSM-35, MCM-22, MCM-36, MCM-41, MCM-48, SAPO-34, rare earth substituted forms of any of the foregoing zeolites, or a combination comprising at least one of the foregoing zeolites.

12. The catalyst system of claim 1, wherein the SCR material comprises a catalytic metal oxide.

13. The catalyst system of claim 12, wherein the metal oxide comprises an oxide selected from the group consisting of gallium oxide, silver oxide, indium oxide, and cerium oxide.

14. The catalyst system of claim 12, wherein the SCR material further comprises a promoting metal.

15. The catalyst system of claim 14, wherein the promoting metal comprises a metal selected from the group consisting of silver, cobalt, molybdenum, tungsten, indium, vanadium, zinc, tin, copper, iron, and bismuth.

16. The catalyst system of claim 14, wherein the SCR material comprises from about 5 mol % to about 31 mol % said catalytic metal oxide and about 0.5 mol % to about 9 mol % said promoting metal, wherein the percentages are fractions of the total amount of SCR material present in the multi-functional catalyst.

17. The catalyst system of claim 1, wherein the SCR material is disposed on the cracking catalyst material.

18. The catalyst system of claim 1, wherein the multi-functional catalyst is disposed on a support structure.

19. The catalyst system of claim 1, wherein the primary hydrocarbon is selected from the group consisting of hydrocarbon-based liquid engine fuels.

20. The catalyst system of claim 19, wherein the primary hydrocarbon comprises diesel fuel.

21. The catalyst system of claim 1, wherein the primary hydrocarbon comprises a hydrocarbon selected from the group consisting of an alkane, an alkene, an alcohol, an ether, an ester, a carboxylic acid, an aldehyde, a ketone, a carbonate, and combinations thereof.

22. The catalyst system of claim 1, wherein the primary hydrocarbon comprises a hydrocarbon selected from the group consisting of ethane, ethylene, propane, propylene, butane, butene, pentane, pentene, hexane, hexene, heptane, heptene, octane, octane, 2,2,4-trimethyl pentane, methanol, ethyl alcohol, butyl alcohol, propyl alcohol, dimethyl ether, dimethyl carbonate, acetaldehyde, acetone, and combinations thereof.

23. A vehicle comprising the catalyst system of claim 1.

24. The vehicle of claim 23, wherein the vehicle is selected from the group consisting of a locomotive, an off-highway vehicle, and a diesel-powered truck.

25. A catalyst system comprising:
a fluid reductant source comprising a primary hydrocarbon; and
a multi-functional catalyst composition disposed in fluid communication with the reductant source, wherein the multi-functional catalyst composition comprises
(a) a cracking catalyst material comprising a zeolite, the cracking catalyst material being capable of enabling the conversion of the primary hydrocarbon of the reductant source into at least one secondary hydrocarbon having a lower molecular weight than the primary hydrocarbon,
(b) a selective catalytic reduction (SCR) material capable of enabling the chemical reduction of NOₓ species, wherein the the SCR material is disposed on the cracking catalyst material, and
(c) a catalytic partial oxidation (CPO) material comprising a platinum-group metal, the CPO material being capable of enabling oxidation of coke deposits on the multifunctional catalyst and of enabling the conversion of the hydrocarbon species to hydrogen and carbon monoxide, wherein the CPO material is disposed on the cracking catalyst material.

26. An apparatus for reducing NOₓ emissions, comprising:
an engine configured to burn a hydrocarbon-based fuel and create an emission; and
an emissions control system configured to accept the emission from the engine, the emissions control system comprising
a reductant injector configured to supply a primary hydrocarbon; and
a multi-functional catalyst composition disposed in fluid communication with the reductant injector, wherein the multi-functional catalyst composition comprises
(a) a cracking catalyst material comprising a zeolite, the cracking catalyst material being capable of enabling the conversion of the primary hydrocarbon of the reductant source into at least one secondary hydrocarbon having a lower molecular weight than the primary hydrocarbon,
(b) a selective catalytic reduction (SCR) material capable of enabling the chemical reduction of NOₓ species, wherein the the SCR material is disposed on the cracking catalyst material, and
(c) a catalytic partial oxidation (CPO) material comprising a platinum-group metal, the CPO material being capable of enabling oxidation of coke deposits on the multifunctional catalyst and of enabling the conversion of hydrocarbon species to hydrogen and carbon monoxide, wherein the CPO material is disposed on the cracking catalyst material.

27. The apparatus of claim 24, further comprising a fuel delivery system configured to provide a first stream of the fuel to the engine and a second stream of fuel to the reductant injector.

28. A method for making a catalyst material, comprising:
providing a primary material, the primary material comprising a zeolite; and
disposing a secondary material with the primary material, wherein the secondary material comprises a selective catalytic reduction (SCR) material.

29. The method of claim 28, wherein disposing the secondary material comprises disposing the secondary material on the primary material.

30. The method of claim 28, further comprising disposing a tertiary material with the primary material, wherein the tertiary material comprises a catalytic partial oxidation (CPO) material.

31. The method of claim 30, wherein disposing the tertiary material comprises disposing the tertiary material on the primary material.

32. The method of claim 28, further comprising disposing the primary material onto a support structure comprising a support material.

33. The method of claim 32, wherein disposing the primary material comprises wash-coating the primary material onto the support structure.

34. The method of claim 32, wherein disposing the primary material comprises mixing the primary material with the support material to form a mixture and extruding the mixture to form the support structure.

35. The method of claim 32, wherein the support structure comprises a monolith structure or a foam structure.

36. A multi-functional catalyst composition comprising
(a) a cracking catalyst material, and
(b) a selective catalytic reduction (SCR) material.

37. The catalyst composition of claim 36, further comprising a catalytic partial oxidation (CPO) material.

38. The catalyst composition of claim 36, wherein the CPO material comprises a platinum-group metal.

39. The catalyst composition of claim 36, wherein the CPO material is disposed on the cracking catalyst material.

40. The catalyst composition of claim 36, wherein the cracking catalyst material comprises a zeolite.

41. The catalyst composition of claim 40, wherein the zeolite comprises ultrastable Y zeolite (USY), beta zeolite, ZSM-5, ZSM-11, ZSM-22, ZSM-35, MCM-22, MCM-36, MCM-41, MCM-48, SAPO-34, rare earth substituted forms of any of the foregoing zeolites, or a combination comprising at least one of the foregoing zeolites.

42. The catalyst composition of claim 36, wherein the SCR material comprises a catalytic metal oxide.

43. The catalyst composition of claim 42, wherein the metal oxide comprises an oxide selected from the group consisting of gallium oxide, silver oxide, indium oxide, and cerium oxide.

44. The catalyst composition of claim 42, wherein the SCR material further comprises a promoting metal.

45. The catalyst composition of claim 44, wherein the promoting metal comprises a metal selected from the group consisting of silver, cobalt, molybdenum, tungsten, indium, vanadium, zinc, tin, copper, iron, and bismuth.

46. The catalyst composition of claim 36, wherein the SCR material is disposed on the cracking catalyst material.

47. A multi-functional catalyst comprising:
(a) a cracking catalyst material comprising a zeolite;
(b) a selective catalytic reduction (SCR) material disposed on the cracking catalyst material; and
(c) a catalytic partial oxidation (CPO) material, comprising a platinum-group metal, disposed on the cracking catalyst material.
